(19) United States
(12) Patent Application Publication
(10) Pub. No.: US 2015/0115148 A1
(43) Pub. Date: Apr. 30, 2015

(54) MASS DISTRIBUTION MEASUREMENT METHOD AND MASS DISTRIBUTION MEASUREMENT APPARATUS

(71) Applicant: CANON KABUSHIKI KAISHA, Tokyo (JP)

(72) Inventors: Naofumi Aoki, Nagoya-shi (JP); Masafumi Kyogaku, Yokohama-shi (JP); Kota Iwasaki, Atsugi-shi (JP)

(21) Appl. No.: 14/515,699

(22) Filed: Oct. 16, 2014

(30) Foreign Application Priority Data
Oct. 30, 2013 (JP) 2013-225691

(51) Int. Cl. H01J 49/00; H01J 49/40

(52) U.S. Cl. CPC H01J 49/0004; H01J 49/0031; H01J 49/40
USPC 250/282; 250/287

(57) ABSTRACT

Projection TOF mass spectrum distribution information is acquired by irradiating a first ionizing beam onto a surface of a specimen to acquire first mass spectrum distribution information on secondary ions generated from the specimen, irradiating a second ionizing beam onto the same surface to acquire second mass spectrum distribution information on secondary ions generated from the specimen irradiation, and correcting the second mass spectrum distribution information by correcting time-of-flight distribution information of secondary ions in the second mass spectrum distribution information on the basis of detection time distribution of an arbitrary peak in the first mass spectrum distribution information.

### BACKGROUND OF THE INVENTION

1. Field of the Invention

The present invention relates to a method of acquiring mass distribution information on a specimen having a non-flat surface. The present invention also relates to an apparatus capable of displaying the acquired mass distribution information as a mass distribution image along with an unevenness image of the specimen surface.

2. Description of the Related Art

Imaging mass spectrometry is realized by applying an imaging technique to mass spectrometry and the development of imaging mass spectrometry is under way as analysis methods of comprehensively visualizing two-dimensional distribution information on a large number of substances that constitute an analysis specimen, which may typically be a biological tissue section. Mass spectrometry is a technique of ionizing a specimen by irradiating the specimen with a laser beam or primary ions, isolating the ionized specimen (secondary ions) by utilizing the mass-to-charge ratio m/z (m: mass of secondary ion, z: valence of secondary ion) and obtaining a spectrum of secondary ions that is expressed on a graph having a horizontal axis representing the m/z ratios and a vertical axis representing the signal intensities of detected secondary ions. The two-dimensional distribution of signal intensities of secondary ions that correspond to respective m/z peak values can be obtained by way of two-dimensional mass spectrometry of the surface of the specimen and hence two-dimensional distribution information (mass imaging) on the substances that correspond to the respective secondary ions can be obtained.

Imaging mass spectrometry that makes use of a time-of-flight type ion analyzer unit for isolating and detecting ions of an ionized specimen on the basis of differences of time-of-flight down to a detector are mainly in use today. Known techniques of ionizing a specimen include Matrix Assisted Laser Desorption/Ionization (MALDI), which is a technique of ionizing a specimen, to which a matrix has been applied or with which a matrix has been mixed, by irradiating the specimen with a pulsed and finely converged laser beam, and Secondary Ion Mass Spectroscopy (SIMS), which is a technique of ionizing a specimen by irradiating a specimen with a primary ion beam. Of the known imaging mass spectrometries, those that utilize MALDI or the like as ionizing technique have already been widely utilized to analyze biological specimens including proteins and lipids. However, with the MALDI technique, the spatial resolution is limited to about several tens of μm because of the principle of utilization of matrix crystal on which it is based. To the contrary, Time of Flight-Secondary Ion Mass Spectroscopy (TOF-SIMS), which is realized by combining an ion irradiation type ionization technique and a time-of-flight type ion detection technique, can provide a high spatial resolution of the order of sub-microns and hence has been drawing attention in recent years as mass spectrometry technique that is applicable to imaging mass spectrometry.

With known imaging mass spectrometries that employ any of the above-described techniques, two-dimensional mass spectrum distribution information is obtained by scanning a beam for ionization and sequentially conducting mass spectrometry for a large number of minute measurement areas. However, scanning type TOF-SIMS as described above is accompanied by a problem that a long period of time has to be spent to acquire a mass image over a broad area.

Imaging mass spectrometry using a two-dimensional collective detection (projection) technique has been proposed to dissolve the above-identified problem. With this method, the components on a large area of a specimen surface are collectively ionized and the two-dimensional distribution of generated secondary ions is straightly projected onto a detection unit so that mass information on the specimen components and the two-dimensional distribution thereof can be acquired at a time to remarkably reduce the measurement time.

Meanwhile, when conducting a mass spectrometry operation on a predetermined surface area of a cut piece of biological tissue or a semiconductor circuit by means of TOF-SIMS and the surface to be analyzed has undulations, slopes or the like, the distance from the specimen surface to the extraction electrode for extracting secondary ions from the specimen surface and accelerating them varies as a function of the position in the area of measurement. Then, there arise variations of flight distance and hence those of time of flight from the point of generation to the detector for secondary ions generated at various positions in the area of measurement. In other words, in an operation of detecting an arbitrary secondary ion, the time the secondary ion spends for flying from the position where it is generated to the detector (the detection time) varies depending on the position where the second ion is generated so that there arises a problem that the two-dimensional distribution of mass information (the mass spectrum including the secondary ion) cannot accurately be measured (and hence the mass resolution is reduced).

With regard to measurement using scanning type TOF-SIMS for specimens having surface undulations, Japanese Patent Application Laid-Open No. 2007-299658 describes a technique of determining in advance the height distribution of a specimen by means of an optical microscope and moving the stage on which the specimen is mounted in the height direction on the basis of the measured height values to maintain the distance between the source of generation of any primary ion and the specimen surface to a constant value.

Japanese Patent Application Laid-Open No. 2011-149755 proposes a technique of dividing an arbitrarily selected area of the surface of a specimen to be observed for a plurality of points of measurement, determining the time of flight spectrum of secondary ions at each of the points of measurement and correcting the variance of flight distance and hence that of time of flight attributable to the differences in height on the specimen surface before adding up the measured values to improve the mass resolution of the obtained measurement spectrums.

With known projection type imaging mass spectrometry apparatus, variations of flight distance of secondary ion arise within the area of measurement (in-surface) due to undulations or slopes on the specimen surface as described above. If such variations arise, in-surface variations of secondary ion detection time also arise to consequently degrade the mass resolution, giving rise to a problem that the two-dimensional distribution of mass information within the area of measurement cannot accurately be obtained. Therefore, the above-identified in-surface variance of flight distance of secondary ion needs to be corrected in order to acquire accurate mass distribution information within the area of measurement.

While the technique described in Japanese Patent Application Laid-Open No. 2007-299658 is effective for scanning TOF-SIMS adapted to scan the surface of a specimen by means of a primary ion beam, the method can hardly be applied to instances where the area of measurement on the surface of a specimen including a large number of points of measurement that are different in height is subjected to a scanning operation for collective mass spectrometry. Additionally, the method requires minute vertical moves of the specimen stage at the time of measurement. Then, the method is accompanied by a technical problem of controlling such moves and a problem of a significant increase of time to be spent for measurement.

The method described in Japanese Patent Application Laid-Open No. 2011-149755 handles the variations of time-of-flight of secondary ion among the points of measurement on the surface of a specimen as variations of flight distance and corrects the variance of flight distance on the basis of the positional variations of the rising edges of arbitrary peaks. However, the variance of time-of-flight of secondary ions that needs to be corrected includes the variance of arrival time of secondary ions at the substrate (the variance of time of generation of secondary ion) and hence the variance of flight distance of secondary ion (unevenness information of the specimen surface) is not accurately determined by this method. For this reason, the method is accompanied by a problem that the method cannot accurately measure the two-dimensional distribution of mass information (the improvement of mass resolution is not satisfactory).

### SUMMARY OF THE INVENTION

According to the present invention, the above-identified problems are dissolved by providing a projection TOF mass spectrum distribution information acquisition method including: a first step of irradiating a first ionizing beam onto a surface of a specimen and acquiring first mass spectrum distribution information on secondary ions generated from the specimen as a result of irradiation of the first ionizing beam; a second step of irradiating a second ionizing beam onto the surface of the specimen and acquiring second mass spectrum distribution information on secondary ions generated from the specimen as a result of irradiation of the second ionizing beam; and a third step of correcting the second mass spectrum distribution information, using the first mass spectrum distribution information; the third step including correcting time-of-flight distribution information of secondary ions in the second mass spectrum distribution information on the basis of detection time distribution of an arbitrary peak in the first mass spectrum distribution information.

In another aspect of the present invention, the above-identified problem is dissolved by providing a projection TOF mass microscope including: a specimen stage for receiving a specimen to be mounted thereon; a first ionizing beam irradiation unit for irradiating a first ionizing beam onto the specimen mounted on the specimen stage; a second ionizing beam irradiation unit for irradiating a second ionizing beam onto the specimen mounted on the specimen stage; a secondary ion detection unit for separating secondary ions generated from the specimen as a result of irradiation of the ionizing beams by mass-to-charge ratio and two-dimensionally detecting the secondary ions; a mass spectrum distribution information acquisition unit for acquiring mass spectrum distribution information from a secondary ion detection signal output from the secondary ion detection unit; a specimen unevenness information acquisition unit for acquiring specimen unevenness information from the mass spectrum distribution information output from the mass spectrum distribution information acquisition unit; a mass spectrum distribution information correction unit for correcting the mass spectrum distribution information on the basis of the specimen unevenness information output from the specimen unevenness information acquisition unit; and an output unit for outputting acquired information, the microscope being configured to acquiring first mass spectrum distribution information by irradiation of the first ionizing beam; acquiring second mass spectrum distribution information by irradiation of the second ionizing beam; acquiring specimen unevenness information from the first mass spectrum distribution information; correcting time-of-flight distribution information of secondary ions in the second mass spectrum distribution information on the basis of the specimen unevenness information; and outputting information including at least one of the second mass spectrum distribution information corrected, the first mass spectrum distribution information used for the correction, and the specimen unevenness information acquired.

Thus, a mass spectrum distribution information acquisition method and a mass microscope according to the present invention can suppress the fall of mass resolution due to inconsistency of data on the flight distance of secondary ions so that highly reliable images can be obtained by mass spectrometry imaging.

Further features of the present invention will become apparent from the following description of exemplary embodiments with reference to the attached drawings.

### BRIEF DESCRIPTION OF THE DRAWINGS

FIG. 1 is a schematic illustration of an exemplary apparatus for executing the method of the present invention, illustrating the configuration thereof;

FIGS. 2A and 2B are schematic illustrations of variations of arrival time of primary beam and variations of flight distance of secondary ions of the projection imaging mass spectrometry; and

FIG. 3 is a flowchart illustrating the steps of the method of the present invention.

### DESCRIPTION OF THE EMBODIMENTS

Preferred embodiments of the present invention will now be described in detail in accordance with the accompanying drawings.

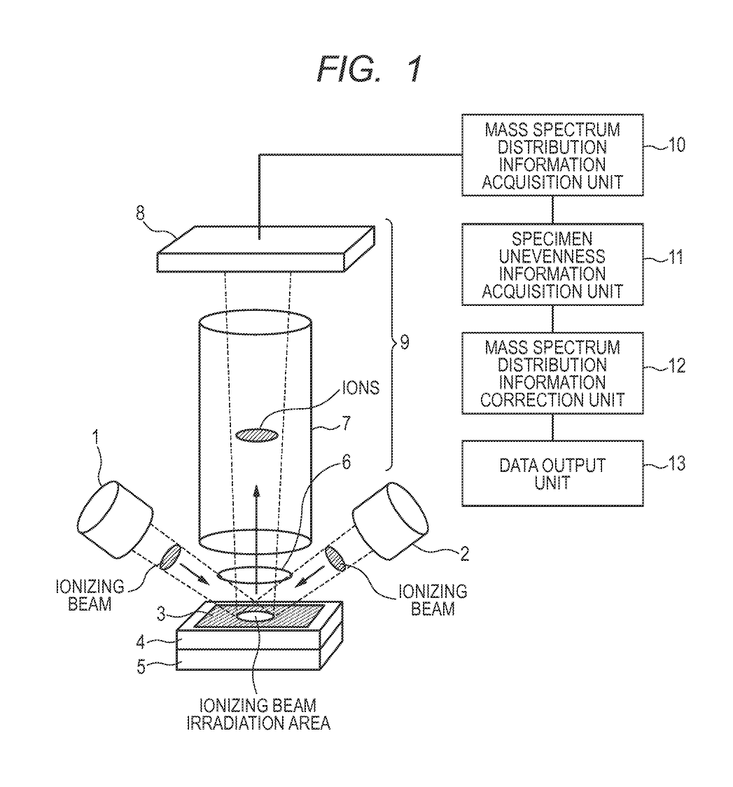

Now, the method of the present invention and the configuration of an apparatus that can suitably be used to execute the method will be described below by referring to FIG. 1. FIG. 1 is a schematic illustration of an exemplary apparatus for executing the method of the present invention, illustrating the configuration thereof. While the present invention will be described below by way of an embodiment thereof, the present invention is by no means limited by the embodiment.

The apparatus illustrated in FIG. 1 includes a projection TOF secondary ion detection unit 9, a first ionizing beam irradiation unit 1 and a second ionizing beam irradiation unit 2, each of the first and second ionizing beam irradiation units 1 and 2 being adapted to irradiate an ionizing beam having a certain spread toward the surface of a spectrum 3. The apparatus further includes a mass spectrum distribution information acquisition unit 10 for acquiring mass spectrum distribution information from the secondary ion detection signal output from the secondary ion detection unit 9, a specimen unevenness information acquisition unit 11 for acquiring specimen unevenness information from the mass spectrum distribution information output from the mass spectrum distribution information acquisition unit, a mass spectrum distribution information correction unit 12 for correcting the mass spectrum distribution information on the basis of the specimen unevenness information output from the specimen unevenness information acquisition unit, and an output unit 13 for outputting the specimen unevenness information and the results of correcting the mass spectrum distribution information.

Specimen 3 is a solid. Any of semiconductor circuits, organic compounds, inorganic compounds, and biological specimens can be selected as specimen for the purpose of the present invention. The specimen 3 is rigidly secured onto substrate 4 having a substantially planar surface. The substrate 4 is mounted onto specimen stage 5. The specimen stage 5 has a translation mechanism so that any arbitrary area on the specimen 3 can be selected as measurement target area by driving the specimen stage 5 to move in X and Y directions.

Generally, with scanning type TOF-SIMS, a pulsed ionizing beam with a diameter of about 1 μm or less is used as an ionizing beam (primary ion beam). On the other hand, with the mass distribution analysis method according to the present invention, which is a projection method, a pulsed ionizing beam that has a two-dimensional width in a direction orthogonal to the travelling direction of the beam is employed in order to additionally detect information on the two-dimensional positions of ions generated from the specimen (secondary ions). In other words, an ionizing beam to be used for the purpose of the present invention can be regarded as a group of particles that is spatially broadened to a certain extent to represent a quasi-disk-shaped or quasi-cylinder-shaped profile as a whole. The irradiation area of an ionizing beam on the specimen surface is determined on the bases of the size of the area of measurement. When, for example, an area that includes a plurality of cells is selected as area of measurement of a biological specimen, an area having a size of several tens of μm to several mm will be selected as irradiation area.

The first ionizing beam and the second ionizing beam are emitted as pulsed beams, in which each pulse has a very short duration, and irradiated toward the specimen 3. Upon receiving the irradiated ionizing beams, secondary ions are generated from the surface of the specimen surface. With a projection type mass spectrometry, since the primary ion beam is two-dimensionally broadened in a plane including the primary ion beam, the ionizing beam is preferably made to strike the specimen surface perpendicularly in order to minimize the in-surface variations of time for primary ions to get to the specimen (and make the clock times of generations of secondary ions close to each other in the irradiation area). However, the ionizing beam may alternatively be made to strike the specimen surface obliquely as viewed from the surface of the substrate 4 in order to avoid the ionizing beam from interfering with the ion optical system that the ion detection unit includes. If such is the case and if necessary, the clock times of generations of secondary ions need to be corrected by considering that the clock times of arrivals of primary ions are shifted to a certain extent along the direction that is defined by projecting the traveling direction of the ionizing beam onto the specimen surface.

A first ionizing beam is in principle faster than a corresponding second ionizing beam. When, for example, a primary ion beam is employed for the second ionizing beam, a pulsed laser beam or a pulsed electron beam may be used for the first ionizing beam. The travelling velocity of the first ionizing beam is preferably such that the variations of arrival time of the ionizing beam to the specimen surface that arises due to the undulations of the specimen can be disregarded. More specifically, the travelling velocity is preferably not less than 1×10⁶ m/s. Alternatively, both the first and second ionizing beams may be pulsed ion beams. If such is the case, the two pulsed ion beams may be formed by using respective ion species that differ from each other or, alternatively, may be ion beams of a same ion species. If the two pulsed ion beams are ion beams of a same ion species, a same ionizing beam irradiation unit may be used for the first ionizing beam irradiation unit 1 and the second ionizing beam irradiation unit 2. Then, the ionizing beam irradiation unit needs to be operated so as to make the velocity of the first ionizing beam greater than that of the second ionizing beam.

The second ionizing beam is in principle a beam having an ability of ionizing the specimen higher than the comparable ability of the first ionizing beam. For example, metal ions such as ions of bismuth, those of gallium or those of gold, or metal cluster ions, or gas cluster ions such as Ar cluster ions may preferably be used. Cluster ions are particularly effective to organic materials such as biological specimens because they provide an effect of alleviating the possible damage to the specimen. Preferable examples of cluster ions include cluster ions of gold, bismuth, xenon and argon, fullerene ions that are carbon based cluster ions, and water-based cluster ions. Water-based cluster ions as used herein is the generic name of cluster ions formed from water or aqueous solution, including water cluster ions, and cluster ions formed by using a mixture of water molecules and other molecules.

The secondary ion detection unit 9 is constructed by using an extraction electrode 6 for accelerating secondary ions generated from a specimen as a result of irradiation of ionizing beams, a time-of-flight type mass spectrometry section 7 in which accelerated secondary ions fly at a constant speed, and a two-dimensional ion detection section 8. Secondary ions that are generated from a specimen pass through the mass spectrometry section 7, maintaining the positional relationship of the secondary ions that is observed at the positions of generations of secondary ions on the surface of the specimen 3, and then are detected by the two-dimensional ion detection section 8.

The extraction electrode 6 and the substrate 4 are arranged at respective positions that are separated by a gap of about 1 to 10 mm and voltage V_{d} is applied to the gap in order to extract secondary ions. V_{d} is between about 100 V and about 10 kV, which may be either a positive voltage or a negative voltage. Secondary ions having mass m are accelerated by the voltage V_{d} before they enter the mass spectrometry section 7. A plurality of electrodes (not illustrated) for constructing a projection type optical system may appropriately be arranged downstream relative to the extraction electrode 6. These electrodes provide a converging effect of limiting the spatial spreading of secondary ions and a magnifying effect and any magnifying power can be arbitrarily selected by changing the voltage that is applied to the electrodes.

The mass spectrometry section 7 is constructed by a cylindrical member (mass sepectrometer tube), which is generally referred to as flight tube. There is no electric potential gradient in the inside of the flight tube and hence secondary ions fly at a constant speed in the flight tube. Since the time-of-flight is proportional to the root of m/z (m: mass of secondary ion, z: valence of secondary ion), the time-of-flight can be measured from the difference between the time of generation of a secondary ion and the time of detection of the secondary ion to thereby acquire m/z of the generated secondary ion. From the viewpoint of improving the mass resolution, the use of a longer flight tube is advantageous, although the use of a long flight tube can make the entire apparatus bulky. By taking these factors into consideration, the length of the flight tube is preferably within the range extending between 1,000 mm and 3,000 mm.

The secondary ions that pass through the mass spectrometry section 7 are projected onto the two-dimensional ion detection section 8 and the secondary ion detection signal obtained at the two-dimensional ion detection section 8 is sent to the mass spectrum distribution information acquisition unit 10. The mass spectrum distribution information acquisition unit 10 outputs a signal in which the detection intensity and the position on the two-dimensional detector are associated for each ion. In other words, the signal is output as three-dimensional data that provide spectrum information for each position (mass spectrum distribution information). A projection adjustment electrode (not illustrated) that operates to construct an ion lens for adjusting the projection magnifying power may be arranged between the two-dimensional ion detection section 8 and the mass spectrometry section 7.

The two-dimensional ion detection section 8 may have any configuration so long as it can output information on the times and the positions of ion detections along with the detected signal intensities. For example, the two-dimensional ion detection section 8 may be constructed by combining a micro channel plate (MCP) and a two-dimensional photo detector, which may be a fluorescent plate or a charge-coupled device (CCD). By using a CCD detector that is normally employed for an ultra-high speed camera, images can be picked up on a time division basis by means of a shutter that operates at high speed. Then, images of ions whose arrival times at the detector can be picked up separately and individually for each image pickup frame so that mass-separated ion distribution images can be collectively obtained at a time. Besides, an MCP and a two-dimensional detector that can record the positions of electron detections along with detection times can be combined for use. For example, a delay line detector that employs a wire for detection of electrons or a semiconductor array detector that can record the arrival times of electrons for each pixel may be used.

(Operation)

Now, the effect and the principle of the information acquisition method of the present invention will be described below.

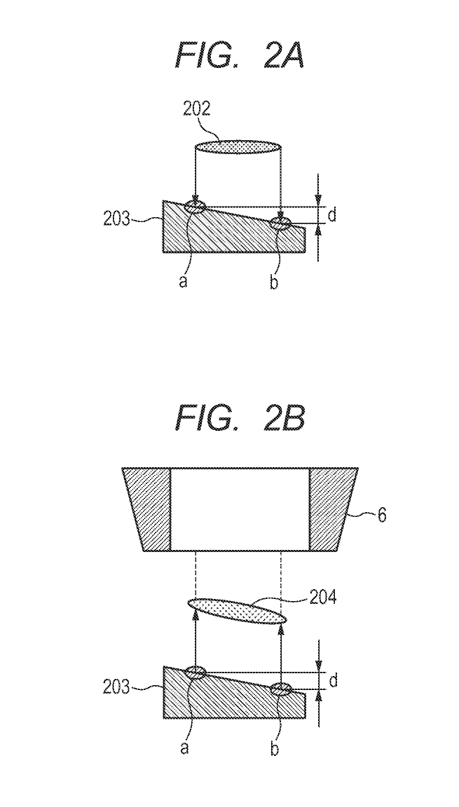

Firstly, in-surface variations of secondary ion generation timing in a surface area of the surface of a specimen will be described by referring to FIG. 2A. Such variations are observed when an ionizing beam (primary beam) having a certain spread and emitted from an ionizing beam irradiation unit strikes the specimen surface 203 having undulations (slopes).

Assume that a primary ion beam 202 is emitted from an ionizing beam irradiation unit and irradiated onto a specimen surface 203 having undulations. Also assume that an arbitrarily selected point of measurement on the specimen surface is point a whereas another arbitrarily selected point of measurement on the specimen surface that is located lower in height than the point a is point b and the difference of height between point a and point b is d. Note that d is not necessarily the largest difference of height between two points hit by the primary ion beam and may simply be the difference of height between two arbitrarily selected points in the irradiated area. If the primary ion beam strikes the specimen surface at a speed of v, the difference of time Δt₁ between the time of arrival of the primary ion beam at point a and the time of arrival of the primary ion beam at point b is expressed by Δt₁=d/v.

Now, in-surface variations of flight distance of secondary ions 204 generated from the specimen surface 203 having undulations will be described be referring to FIG. 2B. In the case of a specimen having surface undulations, there arises variations of flight distance of generated secondary ions in addition to the above-described in-surface variations of secondary ion generation timing.

In the instance of FIG. 2B, the difference of height d between the measurement point a and the measurement point b is the difference of flight distance between the secondary ion generated from point a and the secondary ion generated from point b. If the distance between the specimen and the extraction electrode is D and the voltage at the extraction electrode (accelerating voltage of secondary ions) is V_{acc}, the electric field E between the specimen and the extraction electrode is expressed by E=V_{acc}/D. The time difference Δt₂ between the time of arrival of the secondary ion generated from point a and the time of arrival of the secondary ion generated from point b at the extraction electrode 6 is approximately expressed by Δt₂=d·(2 m/zeV_{acc})^{0.5}.

Note that secondary ions representing the same mass-to-charge ratio m/z represent the same constant velocity v of v=(2zeV/m)^{0.5} when they arrive at the extraction electrode (and hence at the entrance of the flight tube) regardless of the distance D between the specimen and the extraction electrode. In other words, all secondary ions representing the mass-to-charge ratio of m/z fly at the constant velocity of v in the flight tube. Therefore, the undulations of the specimen surface do not affect the time-of-flight in the flight tube.

From the above description, it will be seen that, for each secondary ion, the total duration of time of measurement from the time when the ionizing beam is emitted from the ionizing beam irradiation unit to the time when a secondary ion that is generated from the specimen as a result of the irradiation of the ionizing beam arrives at the secondary ion detection unit can be primarily divided into three stages. More specifically, the total duration of time includes the first duration of time t₁ from the time when the ionizing beam is emitted from the irradiation unit to the time when the ionizing beam arrives at the specimen surface, the second duration of time t₂ from the time when the secondary ion is generated at the specimen surface to the time when the secondary ion gets to the extraction electrode, and the third duration of time t₃ from the time when the secondary ion passes the position of the extraction electrode to the time when the secondary ion is detected by the two-dimensional ion detection section. Of these, the first duration of time t₁ and the second duration of time t₂ can represent variations among secondary ions due to the undulations or the slopes on the specimen surface but the third duration of time t₃ does not give rise to any variation attributable to the undulations on the specimen surface.

The present invention is based on a technical idea of grasping the conditions of the specimen surface in terms of undulations or slopes (and hence acquiring information on the undulations of the specimen surface) by minimizing the variance Δt₁ of the first duration of time t₁ and conducting the measurement in a condition where the variations of the total duration of time t₁+t₂+t₃ of measurement from the time when the ionizing beam is emitted to the time when the secondary ions are detected are substantially attributable only to the variance Δtₜ of the second duration of time and thereafter correcting the data obtained by a measurement conducted in a condition where the variance Δt₁ of the first duration of time cannot be made small on the basis of the grasped conditions of the specimen surface.

The variance Δt₁ of the first duration of time can be minimized by using as ionizing beam a high-speed beam with which the variations of secondary ion arrival time at the specimen surface can be disregarded if the specimen surface has undulations or slopes, although the efficiency of generation of secondary ions of such a high-speed ionizing beam may be relatively poor. As far as the present invention is concerned, the above statement applies to the use of the first ionizing beam. On the other hand, instances where the variance of the first duration of time cannot be made small are those where a high-speed beam cannot be used from the viewpoint of emphasizing the efficiency of generation of secondary ions. As far as the present invention is concerned, such instances correspond to the use of the second ionizing beam. While the velocity of a high-speed beam is normally not less than 1×10⁶ m/s, this requirement is not a requirement that needs to be absolutely satisfied because the velocity required to the first ionizing beam may vary depending on the extent of undulations of the specimen surface.

As described above, mass spectrometry is a technique of obtaining a mass spectrum that is expressed on a graph having a horizontal axis representing the m/z ratio and a vertical axis representing the intensity of detected secondary ions. Then, a secondary ion can be identified from the position on the horizontal axis, or the value of m/z, of a detected peak. Note that the value of m/z corresponds to the time when the secondary ion is detected. In other words, the value of m/z corresponds to the total duration of time of measurement of the secondary ion. Therefore, the existence of variations in the total duration of time of measurement represents the existence of variations among the value of m/z. Then, the width of the peak may be broadened or the peak may be identified as the kind that was different from an accurate ion species.

Referring to FIG. 2A, the arrival time differences Δtₜ at the specimen surface 203 of the primary ion 202 in FIG. 2A is exactly equal to the time differences of the generations of the two secondary ions. In other words, the time difference Δtₜ is added in the total duration of time of measurement of the secondary ion generated at point b, when the two secondary ions have the same mass m (or m/z). Therefore the arrival time difference of the primary ions at the specimen surface causes the generation of the detection time difference Δt₁ of the secondary ions at the ion detection section. In other words, a detection time difference of Δt₁ is produced between measurement point a and measurement point b.

The influence of variations of flight distance (time-of-flight) of secondary ions onto the results of mass spectrometry is similar to the influence of variations of time of generation of secondary ions. In other words, the measured values of the time-of-flight of secondary ions involve Δtₜ and hence a mass difference of Δm₂, which corresponds to the difference of time-of-flight of Δt₂, arises to arbitrary ions having a mass of m. Then, as a result, a fall of mass resolution of several time of u (u: unified atomic mass unit) can be produced depending on the extent of undulations or slopes of the specimen.

The two-dimensional ion detection section 8 measures the distribution of the secondary ions that have arrived at the detector detection positions of which correspond to the respective points of measurement in the surface of specimen. Therefore, if the secondary ions arrived at the detector represent in-surface variations, the signals of some of the secondary ions having the mass of m may be lost and/or the signals of ions having a mass that differs from m by Δm (=Δm₁+Δm₂) may be mixed with the proper signals to interfere with the proper signals and detected with the proper signals. Then, as a result, the mass distribution may not be measured correctly.

In view of the above-identified possible problems, with a mass distribution analysis apparatus according to the present invention, the first mass spectrum distribution information is acquired by irradiation of a first ionizing beam, then unevenness information of the specimen is acquired from the first mass spectrum distribution information and finally the second mass spectrum distribution information is acquired by irradiation of a second ionizing beam. Then, the variance of total duration of time of measurement that is attributable to the variations of flight distance of secondary ions in the second mass spectrum distribution information is corrected on the basis of the acquired unevenness information of the specimen. Then, as a result, a more reliable mass distribution image can be obtained. Additionally, information representing correspondence of unevenness information at each of the in-surface positions in the measured surface of the specimen, the first mass spectrum distribution information that is employed for the correction and the corrected second mass spectrum distribution information can be acquired and output to the outside.

### Embodiment

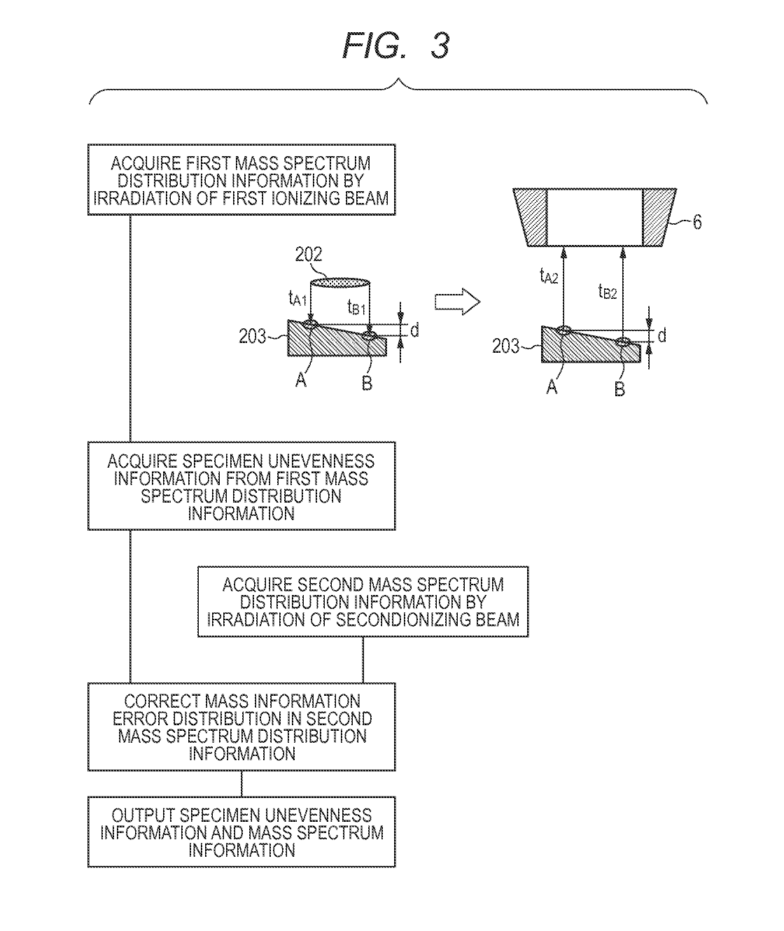

Now, an embodiment of mass spectrum distribution information acquiring method according to the present invention will be described in greater detail below by referring to FIG. 3.

Referring to FIG. 3, assume that the duration of time from the time when the first ionizing beam is emitted to the time when the beam arrives at position A on the specimen surface is t_{A1} and the duration of time from the time when the first ionizing beam is emitted to the time when the beam arrives at position B is t_{B1}. Also assume that the duration of time from the time when ion X (mass mₓ) is generated at position A to the time when the ion X arrives at the extraction electrode is t_{A2} and the duration of time from the time when same ion X is generated at position B to the time when the ion X arrives at the extraction electrode is t_{B2}. Furthermore, assume that the duration of time from the time when the ion X generated at position A passes the extraction electrode to the time when the ion X arrives at the detector is t_{A3} and the duration of time from the time when the ion X generated at position B passes the extraction electrode to the time when the ion X arrives at the detector is t_{B3}.

The first mass spectrum distribution information is acquired by irradiation of the first ionizing beam. Then, attention is paid to an arbitrary peak that is commonly detected from all the positions in the spectrum at each and every position in the two-dimensional distribution contained in the first mass spectrum distribution information. Thereafter, the time of detection of the peak at each of the positions (detection time distribution) is determined. If the peak is attributable to ion X (mass m_{xg}), the detection time at position A is expressed as (t_{A1}+t_{A2}+t_{A3}) and the detection time at position B is expressed as (tₘ+t_{B2}+t_{B3}). As described above, the difference of flight time of the first ionizing beam that arises due to the undulations on the specimen surface can be neglected for the velocity of the first ionizing beam and hence t_{A1}=tₘ is acceptable. The time-of-flight from the extraction electrode to the detector is expressed by t=L_{tube}*(mₓ/2zeV_{acc})^{0.5} and, since the ion generated at position A and the ion generated at position B are the same (equally ion X), t_{A3}=t_{B3} holds true.

The detection time of an arbitrary peak may be the detection time of the peak top. Alternatively, the detection time may be the detection time of the rising edge of the peak or the falling edge of the peak.

As arbitrary peak, the peak of a substance adsorbed to the specimen surface such as the peak of H⁺, the peak of CH₃⁺ or the peak of a substance that is contained in the specimen may be employed. Alternatively, the specimen surface may be coated with metal or an organic compound and the like in advance and the peak of the substance used for the coating may be employed. With ordinary spectrums, the peak of H⁺ is the peak that will be detected first and hence will be detected with ease by automatic detection. Therefore, the peak of H⁺ may preferably be employed.

The coating substance may be formed in advance on the specimen or the apparatus may be provided with a coating mechanism in the inside thereof and the coating operation may be conducted after introducing the specimen into the apparatus. Examples of coating techniques that can be used for the purpose of the present invention include spin coating, sputtering and vacuum evaporation.

With the detection time distribution information of the arbitrary peak that is obtained in this way, secondary ion time-of-flight distribution information (the first time-of-flight distribution information) that corresponds to the peak can be obtained by using the detection time at an arbitrary position on the specimen surface as reference value and subtracting the reference value from the detection time at each position. Then, unevenness information of the specimen can also be obtained.

If, for example, position A is selected as reference, the time lag t_{B}_{_{—}}_{delay} of the time of detection of the ion at position B from the time of detection of the ion at position A is expressed by t_{B}_{_{—}}_{delay}=(t_{Bl}+t_{B2}+t_{B3})−(t_{A1}+t_{A2}+t_{A3}). Since t_{A1}=t_{B1} and t_{A3}=t_{B3}, t_{B}_{_{—}}_{delay}=t_{B2}−t_{A2}, which is equal to the difference of time-of-flight between the ion at position A and the ion at position B (time-of-flight distribution information).

Thus, the difference of time t_{B}_{_{—}}_{delay} for the two secondary ions of the same species generated respectively at position A and position B to get to the extraction electrode 6 is expressed as t_{B}_{_{—}}_{delay}=d*(2 mₓ/zeV_{acc})^{0.5}. Then, the difference of height d between position A and position B (specimen unevenness information using position A as reference) can be determined from this expression.

The second mass spectrum distribution information is acquired by irradiation of the second ionizing beam. The second mass spectrum distribution information may be acquired either before or after the acquisition of the first mass spectrum distribution information. The conditions of measurement for acquiring the second mass spectrum distribution information such as the number of times of averaging and the intervals of averaging for the acquisition of spectrums may differ from the conditions of measurement for acquiring the first mass spectrum distribution information.

Then, mass measurement errors attributable to the undulations of the specimen surface are corrected. This correction is relative correction using an arbitrary position as reference position.

Firstly, the secondary ion detection time information in the second mass spectrum distribution information is corrected by means of the first time-of-flight distribution information. Then, m/z information is obtained from the corrected time information. Now, the correction method will specifically be described below.

The second mass spectrum distribution information can be expressed by means of three-dimensional information (Pᵢ, tⱼ, Iⱼ) of position information Pᵢ, time information tⱼ, and intensity information Iⱼ. Note that i (=1, 2, 3, . . . ) is the index for indicating different measurement positions and j (=1, 2, 3, . . . ) is the index for indicating different peaks of the spectrum observed for position Pᵢ.

The spectrum unevenness information can be expressed by means of two-dimensional information (Pᵢ, dᵢ) of position information Pᵢ and height difference information dᵢ using an arbitrary position as reference position. When position information includes X-coordinate information and Y-coordinate information, position information can be expressed by Pᵢ (xₐ, y_{b}).

In the second mass spectrum distribution information, the difference of time-of-flight Δtᵢ relative to a reference time point at position Pᵢ is expressed by Δtᵢ=dᵢ·(2 m/zeV_{acc})^{0.5}, which can be obtained by using the above expression. Then, as a result, information obtained by reducing the height difference information on the specimen surface to the difference of time-of-flight can be acquired. If the peak used to obtain the first time-of-flight distribution information is attributable to ion X, dᵢ=(zₓeV_{acc}/2 mₓ)^{0.5}*Δtₓ_{_{—}}ᵢ and hence Δtⱼ=Δtₓ_{_{—}}ᵢ*(zₓm/zmₓ)^{0.5}, where Δtₓ_{_{—}}ᵢ is the difference of time-of-flight of ion X at position Pᵢ, zₓ is the valence of ion X, and mₓ is the mass of ion X.

When the time information tⱼ at position Pᵢ is corrected by using the first time-of-flight distribution information, the corrected value tⱼ′ is expressed by tⱼ′=tⱼ−Δtⱼ. Then, from the above formula, m/z is expressed by m/z=2 eV_{acc}*((tⱼ−Δtⱼ)/L_{tube})². Since Δtᵢ=Δtₓ_{_{—}}ᵢ*(zₓm/zmₓ)^{0.5}, m/z=(tⱼ/(L_{tube}/2eV_{acc})^{0.5}+Δtₓ_{_{—}}ᵢ*(zₓm/zmₓ)^{0.5}))² is obtained by substitution and expansion. Thus, m/z information where the variance of time-of-flight attributable to the variance of flight distance of secondary ions is corrected can be obtained.

Then, information including at least one of the unevenness information on the specimen, the information used to correct the unevenness information, and the corrected second mass spectrum distribution information is output.

Preferably, the variance of time of generation of secondary ions is corrected prior to correcting the variance of time-of-flight of secondary ions attributable to the variance of flight distance of secondary ions. For the first and second mass spectrum distribution information obtained by using the first ionizing beam and the second ionizing beam, information on the variance of time of generation of secondary ions can be acquired by determining the detection time distribution at an arbitrary peak and then the difference of detection time between the two distributions at each position. Thus, the difference (at each position) between the secondary ion detection time information of the second mass spectrum distribution information and the information on the variance of time of generation of secondary ions provides information that includes the corrected variance of time of generation of secondary ions.

Thus, with this embodiment of the present invention, when a primary ion beam (second ionizing beam) having a certain spread is irradiated onto a spectrum having surface undulations, the fall of mass resolution due to the variance of flight distance of secondary ions can be prevented and hence a highly reliable mass distribution image can be obtained by rearranging the original mass distribution image on the basis of mass spectrum distribution information.

Additionally, the present invention can provide a mass microscope adapted to acquire information that include unevenness information, corresponding information used for corrections, and corresponding corrected mass spectrum information for each position in the measured surface of a specimen and output the information to the outside.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of the Japanese Patent Application No. 2013-225691, filed Oct. 30, 2013, which is hereby incorporated by reference herein in its entirety.

What is claimed is:

1. A projection TOF mass spectrum distribution information acquisition method comprising:
a first step of irradiating a first ionizing beam onto a surface of a specimen and acquiring first mass spectrum distribution information on secondary ions generated from the specimen as a result of irradiation of the first ionizing beam;
a second step of irradiating a second ionizing beam onto the surface of the specimen and acquiring second mass spectrum distribution information on secondary ions generated from the specimen as a result of irradiation of the second ionizing beam; and
a third step of correcting the second mass spectrum distribution information, using the first mass spectrum distribution information;
the third step including correcting time-of-flight distribution information in the second mass spectrum distribution information on the basis of detection time distribution of an arbitrary peak in the first mass spectrum distribution information.

2. The method according to claim 1, wherein
the third step includes acquiring height difference information of the surface of the specimen from the detection time distribution of the arbitrary peak in the first mass spectrum distribution information.

3. The method according to claim 1, wherein
the third step includes correcting secondary ion detection time information in the second mass spectrum distribution information on the basis of time-of-flight difference information reduced from height difference information of the surface of the specimen.

4. The method according to claim 1, wherein
the velocity of the first ionizing beam is not less than 1×10⁶ m/s.

5. The method according to claim 1, wherein
the velocity of the first ionizing beam is greater than the velocity of the second ionizing beam.

6. The method according to claim 5, wherein
the first ionizing beam is a beam formed by using an ion species that is different from the ion species of the second ionizing beam.

7. The method according to claim 5, wherein
the first ionizing beam is a beam formed by using an ion species that is the same as the ion species of the second ionizing beam.

8. The method according to claim 1, wherein
the first ionizing beam is a pulsed laser beam or a pulsed electron beam.

9. The method according to claim 1, wherein
the second ionizing beam is a pulsed ion beam.

10. The method according to claim 9, wherein
the second ionizing beam is a beam of cluster ions.

11. The method according to claim 10, wherein
the cluster ions are selected from metal cluster ions, gas cluster ions, carbon based cluster ions, and water based cluster ions.

12. The method according to claim 1, wherein
the first mass spectrum distribution information is obtained for a substance arranged on the specimen.

13. The method according to claim 12, wherein
the first mass spectrum distribution information is obtained for a substance adsorbed to the surface of the specimen or a substance contained in the specimen.

14. A projection TOF mass microscope comprising:
a specimen stage for receiving a specimen to be mounted thereon;
a first ionizing beam irradiation unit for irradiating a first ionizing beam onto the specimen mounted on the specimen stage;
a second ionizing beam irradiation unit for irradiating a second ionizing beam onto the specimen mounted on the specimen stage;
a secondary ion detection unit for separating secondary ions generated from the specimen as a result of irradiations of the ionizing beams by mass-to-charge ratio and two-dimensionally detecting the secondary ions;
a mass spectrum distribution information acquisition unit for acquiring mass spectrum distribution information from a secondary ion detection signal output from the secondary ion detection unit;
a specimen unevenness information acquisition unit for acquiring specimen unevenness information from the mass spectrum distribution information output from the mass spectrum distribution information acquisition unit;
a mass spectrum distribution information correction unit for correcting the mass spectrum distribution information on the basis of the specimen unevenness information output from the specimen unevenness information acquisition unit; and
an output unit for outputting acquired information,
the microscope being configured to
acquiring first mass spectrum distribution information by irradiation of the first ionizing beam;
acquiring second mass spectrum distribution information by irradiation of the second ionizing beam;
acquiring specimen unevenness information from the first mass spectrum distribution information;
correcting time-of-flight distribution information of secondary ions in the second mass spectrum distribution information on the basis of the specimen unevenness information; and
outputting information including at least one of the second mass spectrum distribution information corrected, the first mass spectrum distribution information used for the correction, and the specimen unevenness information acquired.

15. The apparatus according to claim 14, wherein
the first ionizing beam is a pulsed ion beam.

16. The apparatus according to claim 14, wherein
the first ionizing beam is a pulsed laser beam or a pulsed electron beam.

17. The apparatus according to claim 14, wherein
the second ionizing means is a pulsed ion beam.

18. The apparatus according to claim 17, wherein
the second ionizing beam is a beam of cluster ions.

19. The apparatus according to claim 18, wherein
the cluster ions are selected from metal cluster ions, gas cluster ions, carbon based cluster ions, and water based cluster ions.

20. The apparatus according to claim 14, wherein
a single ionizing beam irradiation unit is employed both as the first ionizing beam irradiation unit and as the second ionizing beam irradiation unit.

21. The apparatus according to claim 14, wherein
the secondary ion detection unit comprises an extraction electrode for accelerating secondary ions, a flight tube in which accelerated secondary ions fly at a constant velocity and a two-dimensional ion detection section to which secondary ions are projected after flying through the flight tube.
